(19) United States
(12) Patent Application Publication
(10) Pub. No.: US 2010/0092128 A1
(43) Pub. Date: Apr. 15, 2010

(54) Optical Transceiver module

(75) Inventor: Hideaki Okayama, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/458,770

(22) Filed: Jul. 22, 2009

(30) Foreign Application Priority Data
Oct. 9, 2008 (JP) 2008-262925

(51) Int. Cl. G02B 6/12; G02B 6/34; G02B 6/32

(52) U.S. Cl. 385/14; 385/37; 385/33

(57) ABSTRACT

An optical transceiver module includes a semiconductor laser that emits light along a first optical axis. A grating coupler, located in a plane including the first optical axis, diffracts the emitted light out of the plane and into an external optical system. A photodetector receives incoming light from the external optical system on a second optical axis that passes through the grating coupler at an angle to the plane. The photodetector can be placed parallel to the plane, directly above or below the grating coupler, to create an extremely compact optical transceiver module.

### BACKGROUND OF THE INVENTION

1. Field of the Invention

The present invention relates to a transceiver module.

2. Description of the Related Art

Conventional fiber-to-the-home (FTTH) systems use a single optical fiber for both upstream optical transmission from the subscriber to the central office and downstream optical transmission from the central office to the subscriber. Different wavelengths are used for upstream and downstream transmission, so the optical transceiver modules in an FTTH system must include devices for coupling optical signals with different wavelengths into and out of the optical fiber.

The transceiver module used at the subscriber terminal is referred to as an optical network unit (ONU). The ONUs currently available typically include a laser diode transmitting device, a photodiode receiving device, and optical components with spatially aligned optical axes. A disadvantage of this type of ONU is that the optical components take up space. The need for axial alignment is also a disadvantage.

A type of ONU that uses coupled optical waveguides to eliminate the need for axial alignment is known, having been disclosed in Japanese Patent Application Publication No. H8-163028, but this type of ONU requires separate waveguides for the laser diode and photodiode, an arrangement that also takes up space.

There is an unfulfilled need for a more compact type of optical transceiver module for use in ONUs and elsewhere.

### SUMMARY OF THE INVENTION

An object of the present invention is to provide an optical transceiver module with a reduced size.

The present invention provides an optical transceiver module including a semiconductor laser, a grating coupler, and a photodetector. The semiconductor laser emits outgoing light along a first optical axis. The grating coupler is disposed in a plane including the first optical axis, and diffracts the outgoing light out of the plane and into an external optical system. The photodetector receives incoming light from the external optical system on a second optical axis that passes through the grating coupler at an angle to the plane. The photodetector and the external optical system are on opposite sides of the plane.

Since the photodetector can be placed directly above or below the grating coupler, and since no waveguide is required to couple the photodetector to the external optical system, the entire optical transceiver module can be reduced to a small size.

### BRIEF DESCRIPTION OF THE DRAWINGS

In the attached drawings:

FIG. 1 is a schematic plan view of a transceiver module according to a first embodiment of the invention, showing the semiconductor laser, grating coupler, and optical waveguide;

FIG. 2 is a sectional view of the structure in FIG. 1, also showing the photodetector, a wavelength filter, and the external optical system, represented by an optical fiber;

FIG. 3 is a sectional view of the structure in FIG. 1, showing an alternative arrangement of the photodetector and optical fiber;

FIG. 4 is an enlarged sectional view of the grating coupler in FIG. 1;

FIG. 5 is a graph showing results of simulation of the coupling characteristics of the transceiver module in the first embodiment;

FIG. 6 is a schematic plan view of a transceiver module according to a second embodiment of the invention;

FIG. 7 is a sectional view of the structure in FIG. 6;

FIG. 8 plan view of a transceiver module according to a first variation of the invention;

FIG. 9 is a schematic plan view of a transceiver module according to a second variation of the invention; and

FIG. 10 is a sectional view of the structure in FIG. 9.

### DETAILED DESCRIPTION OF THE INVENTION

Embodiments of the invention will now be described with reference to the attached drawings, in which like elements are indicated by like reference characters.

The words ‘upper’, ‘lower’, ‘top’, and ‘bottom’, when used in the following description, refer to relative positions in the drawings and do not restrict the orientation of the optical transceiver module in use.

### First Embodiment

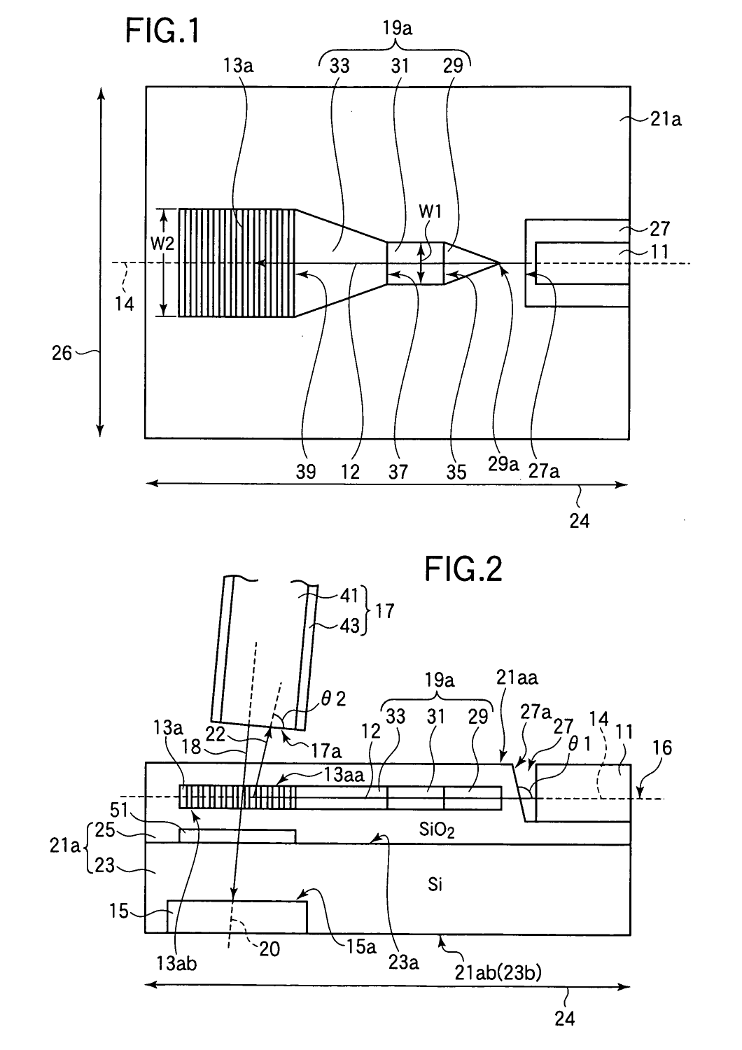

Referring to FIG. 1, the optical transceiver module in the first embodiment has a semiconductor laser 11, a grating coupler 13a, and an optical waveguide 19a, which are formed in or mounted on a substrate 21a with a longitudinal direction or first optical axis direction 24 and a width direction 26.

The semiconductor laser 11 functions as the transmitter in the optical transceiver module by generating outgoing light, referred to below as the upstream optical signal 12. The wavelength of the upstream optical signal 12 is, for example, about 1.31 micrometers (1.31 μm). The semiconductor laser 11 is mounted in a recess 27 in the substrate 21a.

The grating coupler 13a is a rectangular plane waveguide with a series of grooves that diffract the upstream optical signal 12.

The optical waveguide 19a extends from the grating coupler 13a toward the semiconductor laser 11 along a first optical axis 14, forming a path that guides the upstream optical signal 12 from the semiconductor laser 11 into the grating coupler 13a. The optical waveguide 19a and grating coupler 13a are bilaterally symmetric with respect to the first optical axis 14.

In sequence from the semiconductor laser 11 to the grating coupler 13a, the optical waveguide 19a includes a first tapered part 29, a connecting waveguide part 31, and a second tapered part 33. Although the boundary 35 between the first tapered part 29 and connecting waveguide part 31, the boundary 37 between the connecting waveguide part 31 and second tapered part 33, and the boundary 39 between the second tapered part 33 and grating coupler 13a are indicated in the drawing, the first tapered part 29, connecting waveguide part 31, second tapered part 33, and grating coupler 13a are formed integrally as a continuous whole. The connecting waveguide part 31 has a constant width W1; the grating coupler 13a has a constant width W2. At its tip 29a, the first tapered part 29 tapers to a point disposed on the first optical axis 14, facing the semiconductor laser 11. The first tapered part 29 functions as a spot size converter for matching the optical field width of the upstream optical signal 12 to the constant width W1 of the connecting waveguide part 31.

Referring to FIG. 2, the substrate 21a includes a base 23 and a clad 25. The clad 25 is formed on the base 23. The base 23 is composed of single crystalline silicon (Si); the clad 25 is composed of silicon dioxide (SiO₂). The grating coupler 13a and optical waveguide 19a are embedded in the clad 25. The grating coupler 13a and optical waveguide 19a are composed of single crystalline silicon. The grooves of the grating coupler 13a are filled with silicon dioxide clad material.

The substrate 21a and the embedded grating coupler 13a and optical waveguide 19a can be formed easily from a conventional silicon-on-insulator (SOI) substrate having an SiO₂ buried oxide layer sandwiched between a single crystalline silicon base layer (the base 23) and a single crystalline silicon film. Part of the single crystalline silicon film forms the optical waveguide 19a and grating coupler 13a. The other parts of the single crystalline silicon film are selectively removed by conventional photolithography and etching to leave the optical waveguide 19a and grating coupler 13a sitting on the SiO₂ buried oxide layer. Then additional SiO₂ is deposited so that the optical waveguide 19a and grating coupler 13a are embedded in a layer of SiO₂, which becomes the clad 25.

The purpose of the transceiver module in the first embodiment is to transmit an outgoing optical signal to an external optical system (shown as an optical fiber 17 in FIG. 2) and receive an incoming optical signal from the external optical system. Accordingly although the first embodiment is not limited to the materials described above, at least the components through which the outgoing and incoming optical signals pass must be transparent to these signals.

The grating coupler 13a and optical waveguide 19a form an optical waveguide extending laterally and longitudinally in a plane 16 that includes the first optical axis 14. This plane 16 is orthogonal to the thickness direction (the vertical direction in FIG. 2) of the substrate 21a and parallel to the upper surface 23a of the base 23. A preferred thickness of the grating coupler 13a and optical waveguide 19a is 0.3 μm. The grooves in the grating coupler 13a are cut in the thickness direction of the substrate 21a. Light 12 propagating in the direction of the first optical axis 14 (the first optical axis direction 24) encounters the grooves successively.

The refractive index of the single crystalline silicon material forming the optical waveguide 19a and grating coupler 13a is 3.5. The refractive index of the SiO₂ forming the clad 25 and filling the grooves in the grating coupler 13a is 1.46.

The clad 25 is partially removed from the upper surface 21aa of the substrate 21a to form the recess 27 in which the semiconductor laser 11 is mounted. The recess 27 is square in plan view, and extends vertically in the depth direction of the substrate 21a. The front wall 27a of the recess 27 is inclined at an angle θ1 to plane 16. In order to prevent the upstream optical signal 12 from being reflected by the front wall 27a back into the resonant cavity (not shown) of the semiconductor laser 11, this angle θ1 is slightly greater than ninety degrees, so that the first optical axis 14 intersects the front wall 27a at an oblique angle.

As seen in FIG. 2, the optical transceiver module also includes a photodetector element 15 and a wavelength filter 51.

The photodetector element 15 is, for example, a conventional photodiode that functions as a photodetector for receiving the incoming light, referred to below as the downstream optical signal 18, from the external optical system or optical fiber 17. The wavelength of the downstream optical signal 18 differs from the wavelength of the upstream optical signal 12. A preferred wavelength of the downstream optical signal 18 is about 1.49 μm.

The optical fiber 17 is separate from the main unit of the optical transceiver module. Diffracted light 22 of the upstream optical signal 12 enters the optical fiber 17 through an optical input-output facet or end facet 17a facing the upper surface 13aa of the grating coupler 13a, and is transmitted over the optical fiber 17 to an external transceiver in a central office or other facility.

The optical fiber 17 may be a conventional optical fiber including a core 41 surrounded by a cladding 43 having a smaller refractive index than the core 41. The end facet 17a of the optical fiber 17 has substantially the same area as the upper surface 13aa of the grating coupler 13a.

In order to prevent diffracted light 22 from being reflected back to the semiconductor laser 11 by the end facet 17a of the optical fiber 17, the optical fiber 17 is preferably slightly tilted with respect to plane 16. Accordingly, the angle θ2 between the end facet 17a and the optical axis of the diffracted light 22 should differ from a right angle.

The upstream optical signal 12 is TE-polarized with respect to plane 16, and propagates in the waveguide 19a and grating coupler 13a in the transverse electric mode. The diffracted light 22 is symmetrically branched with respect to plane 16 in the thickness direction of the substrate 21a; that is, diffracted light 22 exits from both the upper surface 13aa and lower surface 13ab of the grating coupler 13a. Accordingly, although FIG. 2 shows the optical fiber 17 facing the upper surface 21aa of the substrate 21a, the optical fiber 17 could equally well face the lower surface 21ab of the substrate 21a, as will be shown later.

The photodetector element 15 is disposed on the opposite side of plane 16 from the optical fiber 17. In FIG. 2 the photodetector element 15 is embedded in the base 23, substantially directly below the grating coupler 13a. The upper surface or light-receiving surface 15a of the photodetector element 15 faces the end facet 17a to receive the downstream optical signal 18, which passes straight through the grating coupler 13a. The optical fiber 17, the grating coupler 13a, and the photodetector element 15 are aligned on a second optical axis 20, which is the optical axis of the downstream optical signal 18. To reduce the necessary area of the grating coupler 13a, the second optical axis 20 preferably intersects plane 16 at an orthogonal angle, or substantially orthogonal angle.

The wavelength filter 51 is disposed between the grating coupler 13a and photodetector element 15. In FIG. 2 the wavelength filter 51 is formed on the upper surface 23a of the base 23. The wavelength filter 51 is, for example, a dielectric multilayer filter or another known type of filter. The wavelength filter 51 is transparent to light of the wavelength of the downstream optical signal 18 and reflects light of other wavelengths, including the wavelength of the diffracted light 22.

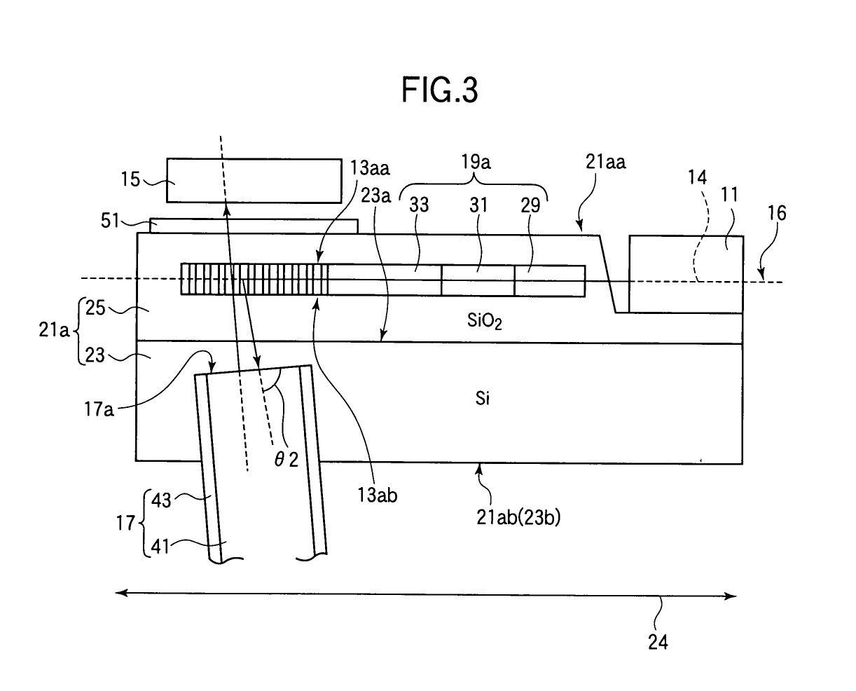

The positions of the photodetector element 15 and optical fiber 17 may be interchanged as shown in FIG. 3, so that the photodetector element 15 is disposed above the grating coupler 13a and the optical fiber 17 is disposed below the grating coupler 13a. The tip of the optical fiber 17, including the end facet 17a, is preferably embedded in the base 23, in an opening formed for this purposes in the lower surface 21ab of the substrate 21a (the lower surface 23b of the base 23), and is fixedly secured. The wavelength filter 51 may be disposed on the upper surface 21aa of the substrate 21a, as shown, and the photodetector element 15 may be mounted above the wavelength filter 51, separate from the substrate 21a.

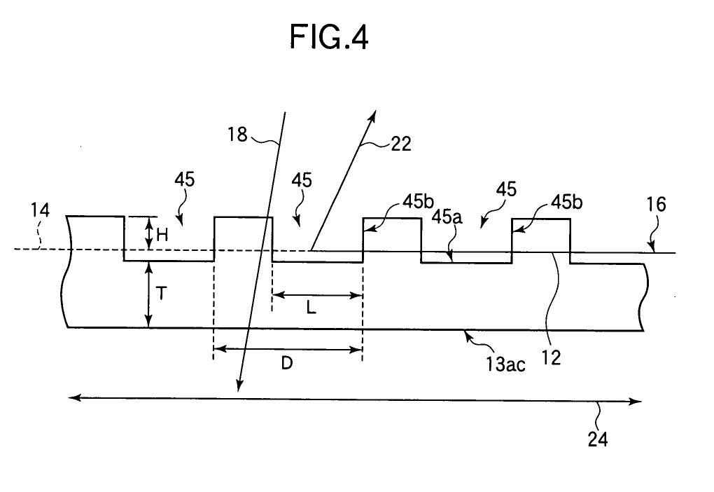

The grating dimensions of the grating coupler 13a will now be described with reference to FIG. 4.

The grating coupler 13a functions as a Bragg diffraction grating. The grooves 45 of the grating coupler 13a are designed to diffract light with the wavelength of the upstream optical signal 12 and transmit light with the wavelength of the downstream optical signal 18. If the wavelengths of these signals and the refractive indexes of the grating and clad materials have the values given above, then the grating spacing D is preferably 0.48 μm, the height H of the grooves 45 is preferably 0.1 μm, and the thickness T from the lower surface 13ac of the grating coupler 13a to the bottom surface 45a of the grooves 45 is preferably 0.162 μm. The duty cycle, which is the ratio of the groove length L measured in the first optical axis direction 24 to the grating spacing D, is preferably 60%.

The structure described above makes possible an extremely compact transceiver module in which the combined length of the integrally formed grating coupler 13a and optical waveguide 19a is 100 μm or less. Specific preferred lengths of the first tapered part 29, connecting waveguide part 31, second tapered part 33, and grating coupler 13a, measured in the first optical axis direction 24, are 15 μm, 10 μm, 50 μm, and 10 μm, respectively. The width W1 of the first tapered part 29 is preferably 0.3 μm; the width W2 of the grating coupler 13a is preferably 10 μm.

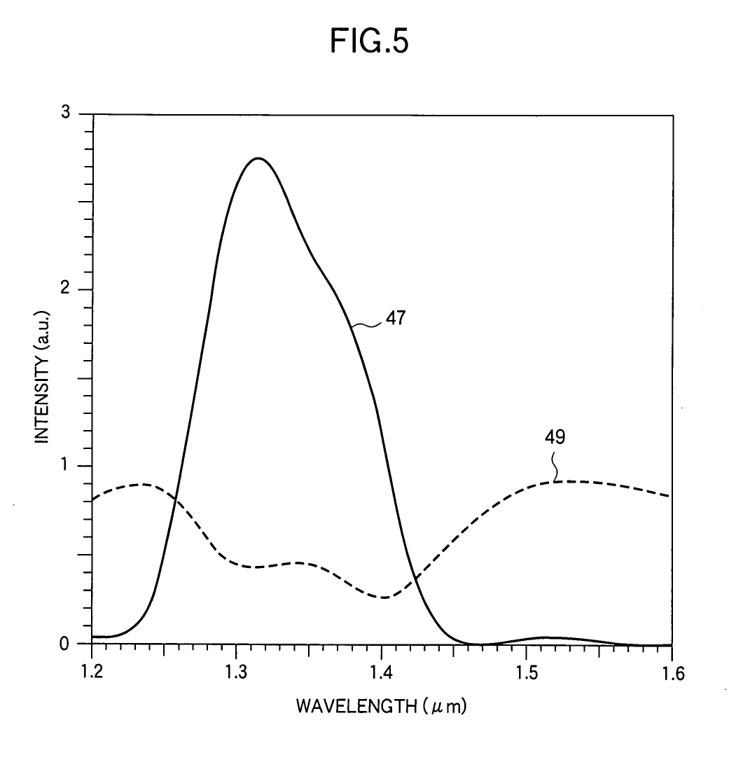

A simulation was carried out by the finite difference time domain (FDTD) method to verify the coupling characteristics of the optical transceiver module in the first embodiment, using the configuration shown in FIGS. 1 and 2. A simulated light source was assumed to be located at the position of the end facet 17a of the optical fiber 17 and the intensities of light propagating from that position to the semiconductor laser 11 and photodetector element 15 were calculated. The simulation results are shown by the graph in FIG. 5. The horizontal axis indicates wavelength in micrometers (μm); the vertical axis indicates optical intensity in arbitrary units (a.u.), the intensity of the light source having a value of unity (1).

Curve 47 indicates the intensity of light of different wavelengths reaching the position of the semiconductor laser 11 from the simulated light source. The optical path taken by this light is reverse but otherwise identical to the propagation path of the upstream optical signal 12 output from the semiconductor laser 11 into the optical fiber 17. Since light propagates reversibly, the optical intensity of the upstream optical signal 12 input to the optical fiber 17 can also be inferred from curve 47. The presence of a wavelength band in which the optical intensity on curve 47 exceeds unity is due to the compression of light as it propagates from the wide end of the second tapered part 33 to the narrow end of the first tapered part 29 of the optical waveguide 19a.

Curve 49 indicates the intensity of light of different wavelengths reaching the position of the photodetector element 15 from the simulated light source. The optical path taken by this light is identical to the propagation path of the downstream optical signal 18 output from the optical fiber 17 to the photodetector element 15.

As indicated by curve 47, the optical intensity on the propagation path of the upstream optical signal 12 is greatest when the wavelength of the light is 1.3 μm, which is substantially equal to the 1.31-μm wavelength of the upstream optical signal 12. This demonstrates that the grating coupler 13a selectively diffracts light with the wavelength of the upstream optical signal 12, thereby establishing the propagation path of the upstream optical signal 12.

Curve 49 indicates that the optical intensity of light with a wavelength of about 1.3 μm propagating from the simulated light source straight through the grating coupler 13a to the photodetector element 15 is about 0.4; that is, about 40% of the light is transmitted through the grating coupler 13a. The diffraction efficiency of the grating coupler 13a at this wavelength is accordingly about 60%. This simulation shows that the upstream optical signal 12 is diffracted efficiently by the grating coupler 13a.

Curve 49 also shows that the greatest optical intensity of light arriving at the photodetector element 15 by following the propagation path of the downstream optical signal 18 from the simulated light source is about 0.8, and that this intensity is reached at a wavelength of about 1.5 μm. The wavelength of the downstream optical signal 18 is about 1.49 μm, so it can be inferred that the downstream optical signal 18 will be reliably transmitted through the grating coupler 13a. This inference confirms the propagation path of the downstream optical signal 18.

### Second Embodiment

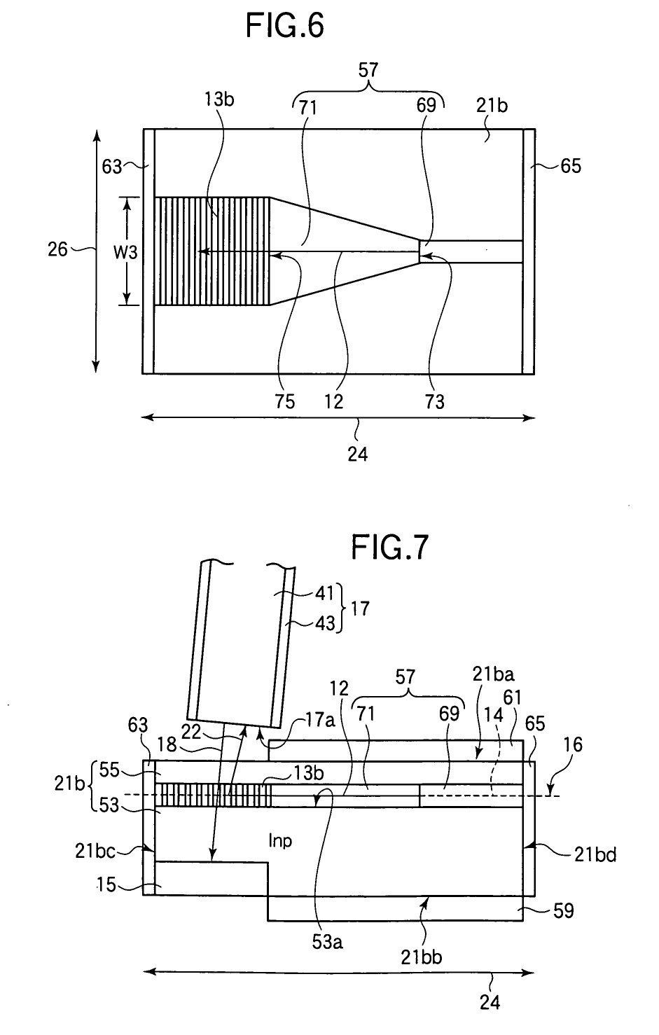

An optical transceiver module according to a second embodiment will be described with reference to FIGS. 6 and 7.

The optical transceiver module in the second embodiment differs from the optical transceiver module in the first embodiment mainly in that the semiconductor laser is integrated with the optical waveguide and grating coupler to reduce the length of the optical transceiver module. The other transceiver components and their functions are the same as in the first embodiment; repeated descriptions will be omitted.

This optical transceiver module is also used to transmit optical signals to and receive optical signals from an external optical system (optical fiber) 17.

Referring to FIG. 6, the optical transceiver module in the second embodiment has a grating coupler 13b similar to the grating coupler 13a in the first embodiment and an optical waveguide 57, aligned in the first optical axis direction 24 of a base 21b. The optical transceiver module in the second embodiment also includes a pair of mirrors 63 and 65 extending in the width direction 26, mounted on opposite ends of the base 21b.

The grating coupler 13b has a constant width W3. The optical waveguide 57 consists of an output part 69 and a tapered part 71 collectively corresponding to the semiconductor laser 11 in the first embodiment. The width of the tapered part 71 gradually decreases from its boundary 75 with the grating coupler 13b to its boundary 73 with the output part 69. The grating coupler 13b and optical waveguide 57 are bilaterally symmetric with respect to the optical axis of the upstream optical signal 12.

Referring to FIG. 7, the base layer 53 is one part of a substrate 21b corresponding to the substrate 21a in the first embodiment. The substrate 21b also includes a top layer 55 that covers the grating coupler 13b and optical waveguide 57.

The base layer 53 is composed of indium phosphide (InP) doped with a p- or n-type impurity; the top layer 55 is composed of InP doped with the opposite type (n- or p-type) of impurity. The p-type impurity may be, for example boron (B) or aluminum (Al); the n-type impurity may be, for example, phosphorus (P) or arsenic (As). The impurities are not limited to these materials.

The grating coupler 13b and the optical waveguide 57 are formed integrally of indium gallium arsenide phosphide (InGaAsP). The grating coupler 13b and optical waveguide 57 are disposed between the base layer 53 and top layer 55 in the substrate 21b, parallel to the upper surface 53a of the base layer 53.

Electrodes 59 and 61 are formed on the upper surface 21ba and lower surface 21bb of the substrate 21b, disposed above and below the optical waveguide 57, though separated from the optical waveguide 57 by the base layer 53 and top layer 55.

The mirrors 63, 65 formed on the end walls 21bc, 21bd of the substrate 21b function as the end reflectors of a semiconductor laser resonator that includes the optical waveguide 57 as its active region.

When the substrate 21b is electrically biased from the electrodes 59 and 61, the entire device functions as a semiconductor laser, generating an upstream optical signal 12 that propagates from the optical waveguide 57 to the grating coupler 13b along the first optical axis 14. As in the first embodiment, the first optical axis 14 lies in a plane 16 orthogonal to the thickness direction (the vertical direction in FIG. 7) of the substrate 21b and parallel to the upper surface 53a of the base layer 53, and the upstream optical signal 12 propagates in this plane 16 as TE polarized light, its electric field components being parallel to plane 16.

The upstream optical signal 12 is selectively diffracted by the grating coupler 13b, which has the structure shown in FIG. 4, and is transmitted to the optical fiber 17 as the diffracted light 22 as in the first embodiment, while the downstream optical signal 18 is transmitted through the grating coupler 13b to the photodetector 15 without being diffracted.

The second embodiment may also include a wavelength filter as in the first embodiment, although this is not shown in the drawings.

The structure employed in the second embodiment reduces the overall size of the optical transceiver module.

### First Variation

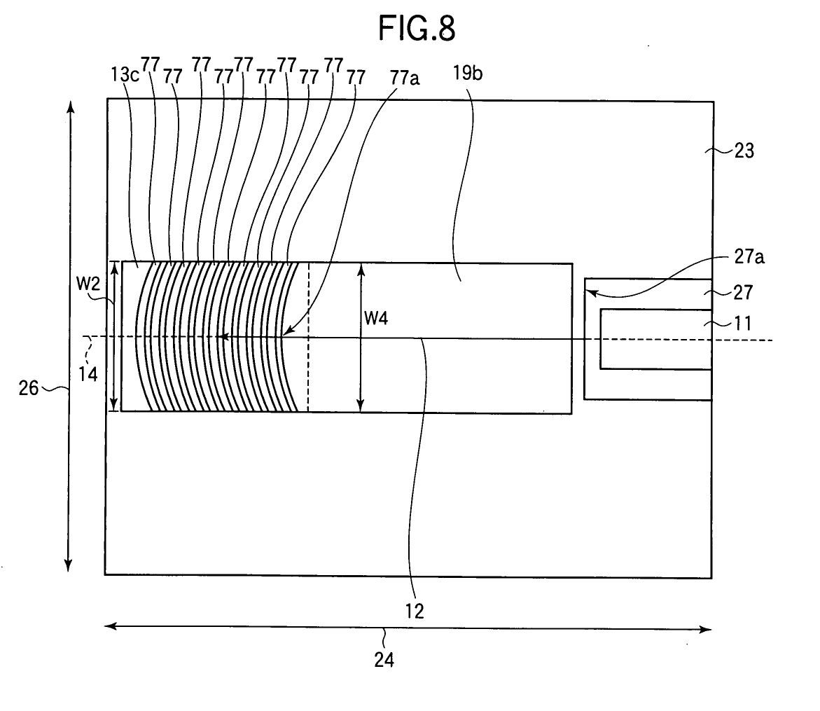

The grating coupler 13a in the first embodiment or the grating coupler 13b in the second embodiment may have the modified structure shown in FIG. 8. The other components of the optical transceiver module and their functions are the same as in the first or second embodiment and will not be described. The structure of the grating coupler in this variation will be described mainly with reference to FIG. 8, but reference will also be made to other drawings. When the first embodiment is referred to, the configuration shown in FIG. 2 will be assumed.

The grating coupler 13c in FIG. 8 is a planar waveguide disposed in the same plane 16 as the grating coupler 13a or grating coupler 13b in the first or second embodiment, but grating coupler 13c has a series of arcuate grooves 77 that provide a light focusing function. The diffracted light 22 of the upstream optical signal 12 is focused toward the end facet 17a of the optical fiber 17 in FIG. 2 by the grating coupler 13c in FIG. 8.

As in the first embodiment, the grooves 77 are designed to diffract light with the wavelength of the upstream optical signal 12 and transmit light with the wavelength of the downstream optical signal 18. The shapes and dimensions of the grooves 77 in a cross section taken through the first optical axis 14 in the thickness direction of the substrate 21a are the same as the shapes and dimensions of the grooves 45 in FIG. 4.

In a cross section in plane 16 or a plane parallel to plane 16 each groove 77 describes a circular arc. The upstream optical signal 12 is incident on the center of each groove 77 from the side of its center of curvature. The radius of curvature of the grooves 77 is selected to focus the diffracted light 22 efficiently toward the end facet 17a; the appropriate radius of curvature depends on the positional relationship between the grating coupler 13c and the end facet 17a of the optical fiber 17.

Because the diffracted light 22 is efficiently focused toward the end facet 17a of the optical fiber 17 by the grooves 77 of the grating coupler 13c, the optical field distribution of the upstream optical signal 12 need not be aligned with the width W2 of the grating coupler 13c in the width direction 26. This eliminates the need for the first tapered parts 29, 33, 71 in the first and second embodiments. Accordingly, when the grating coupler 13c is used in the optical transceiver module in the first embodiment, the dimension W4 of the optical waveguide 19b in the width direction 26 may be uniformly identical to the width W2 of the grating coupler 13c; when the grating coupler 13c is used in the optical transceiver module in the second embodiment, the dimension of the optical waveguide 57 in FIG. 6 in the width direction 26 may be uniformly identical to width W3 in FIG. 6.

By eliminating the need to form the tapered parts 29, 33, 71 in the first and second embodiments, the first variation simplifies the fabrication process of the optical transceiver module.

### Second Variation

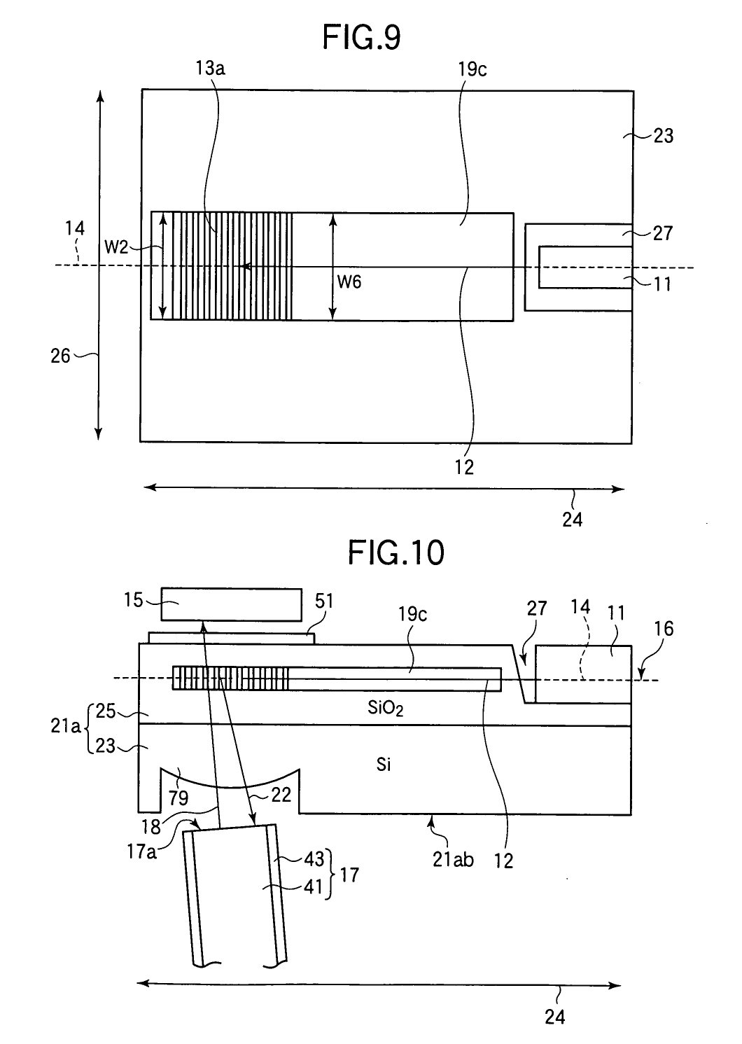

The optical transceiver module in the first or second embodiment may have a modified structure including a lens as shown in FIGS. 9 and 10. The other components of the optical transceiver module and their functions are the same as in the first or second embodiment, so descriptions will be omitted.

The lens in FIGS. 9 and 10 is disposed in the version of the optical transceiver module in the first embodiment shown in FIG. 3.

In the second variation, as shown in FIG. 10, the lens 79 is used to focus the diffracted light 22 transmitted from the grating coupler 13a onto the end facet 17a of the optical fiber 17.

The lens 79 is disposed directly below the grating coupler 13a, between the grating coupler 13a and the optical fiber 17. The area of the lens 79 is substantially equal to the area of the grating coupler 13a or slightly larger, so that a projection of the lens onto plane 16 would cover the grating coupler 13a. The lens 79 collimates the diffracted light 22 and help to couple the diffracted light 22 into the optical fiber 17. The shape of the lens 79 should be optimized to focus the diffracted light 22 efficiently toward the end facet 17a of the optical fiber 17. The optimal lens shape depends on the wavelength of the diffracted light 22, i.e., the wavelength of the upstream optical signal 12, and the positional relationship between the grating coupler 13a and the end facet 17a.

In the structure shown in FIG. 10, the optical fiber 17 is disposed below the lower surface 21ab of the substrate 21a and the lens 79 is formed in the base 23 by partial removal of the base material to create a recessed convex surface. In an alternative structure (not shown), the base 23 is left intact and a separate lens is disposed between the lower surface 21ab of the substrate 21a and the optical fiber 17.

In this variation, the lens 79 efficiently focus the diffracted light 22 toward the end facet 17a, so the optical field distribution of the upstream optical signal 12 need not be aligned with the width W2 of the grating coupler 13a in the width direction 26 in FIG. 9. This eliminates the need for the tapered waveguide parts 29, 33, 71 in the first and second embodiments. Accordingly, when this variation is applied to the optical transceiver module in the first embodiment, the width W6 of the optical waveguide 19c in the width direction 26 may be the same as the width W2 of the grating coupler 13a; when this variation is applied to the optical transceiver module in the second embodiment, the dimension of the optical waveguide 57 in FIG. 6 in the width direction 26 may be uniformly identical to width W3 in FIG. 6.

The lens 79 also eliminates the need for the arcuate groove shape employed in the grating coupler 13c in FIG. 8. Since neither tapered waveguides nor curved grooves are required, the fabrication process for the second variation is even easier than the fabrication process for the first variation.

Those skilled in the art will recognize that further variations are possible within the scope of the invention, which is defined in the appended claims.

What is claimed is:

1. An optical transceiver module for coupling light into and out of an external optical system, the optical transceiver module comprising:
a semiconductor laser for emitting outgoing light along a first optical axis;
a grating coupler disposed in a plane including the first optical axis, for diffracting the outgoing light out of the plane and into the external optical system; and
a photodetector disposed to receive incoming light from the external optical system on a second optical axis passing through the grating coupler at an angle to the plane, the photodetector and the external optical system being on mutually opposite sides of the plane.

2. The optical transceiver module of claim 1, further comprising a wavelength filter disposed between the grating coupler and the photodetector, for transmitting the incoming light and blocking the outgoing light.

3. The optical transceiver module of claim 1, further comprising an optical waveguide disposed in the plane for guiding the outgoing light into the grating coupler

4. The optical transceiver module of claim 3, wherein the optical waveguide is integral with the grating coupler.

5. The optical transceiver module of claim 3, wherein the optical waveguide comprises:
a connecting part narrower than the grating coupler;
a first tapered part tapering from the connecting part to a point on the first optical axis; and
a second tapered part tapering from the grating coupler to the connecting part.

6. The optical transceiver module of claim 3, further comprising a substrate in which the grating coupler and the optical waveguide are embedded.

7. The optical transceiver module of claim 6, wherein the photodetector is embedded in the substrate.

8. The optical transceiver module of claim 6, wherein the external optical system includes an optical fiber with an optical input-output end, the optical input-output end being embedded in the substrate.

9. The optical transceiver module of claim 6, wherein the substrate includes a recess in which the semiconductor laser is mounted.

10. The optical transceiver module of claim 9, wherein the recess has a wall inclined at an oblique angle to the plane and the first optical axis passes through said wall.

11. The optical transceiver module of claim 3, wherein the substrate further comprises:
a silicon base; and
a silicon dioxide clad disposed on the silicon base, the grating coupler and the optical waveguide being embedded in the clad, the grating coupler and the optical waveguide comprising single crystalline silicon.

12. The optical transceiver module of claim 1, wherein the semiconductor laser is integral with the grating coupler.

13. The optical transceiver module of claim 12, wherein the semiconductor laser further comprises:
an optical waveguide disposed on the first optical axis;
a first mirror disposed orthogonal to the first optical axis and adjacent to the grating coupler; and
a second mirror disposed orthogonal to the first optical axis and adjacent to the optical waveguide.

14. The optical transceiver module of claim 13, wherein the semiconductor laser further comprises:
a base layer parallel to the plane;
a top layer parallel to the plane, the plane being disposed between the base layer and the top layer;
a first electrode disposed on the base layer; and
a second electrode disposed on the top layer.

15. The optical transceiver module of claim 14, wherein the base layer and the top layer comprise indium phosphide and the grating coupler and the optical waveguide comprise indium gallium arsenide phosphide.

16. The optical transceiver module of claim 14, wherein the photodetector is embedded in the base layer.

17. The optical transceiver module of claim 1, wherein the external optical system has an optical input-output facet and the grating coupler has arcuate grooves that focus the outgoing light toward the optical input-output facet.

18. The optical transceiver module of claim 1, further comprising a lens disposed between the grating coupler and the external optical system.

19. The optical transceiver module of claim 18, further comprising a substrate, the grating coupler being embedded in the substrate, the lens being integral with the substrate.

20. The optical transceiver module of claim 19, wherein the lens comprises a recessed convex surface of the substrate.
